(19) United States
(12) Patent Application Publication
(10) Pub. No.: US 2004/0140725 A1
(43) Pub. Date: Jul. 22, 2004

(54) ROTARY ELECTRICAL APPARATUS

(75) Inventor: Hideaki Takahashi, Shuuchi-gun (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Shuuchi-gun (JP)

(21) Appl. No.: 10/707,688

(22) Filed: Jan. 5, 2004

(30) Foreign Application Priority Data
Jan. 16, 2003 (JP) 2003-008740

(51) Int. Cl. H02K 21/12; H02K 1/27

(52) U.S. Cl. 310/156.21; 310/156.23; 310/156.28

(57) ABSTRACT

A plurality of embodiments of rotating electrical machines having improved arrangements for securing plate type permanent magnets to a cylindrical surface of one component of the machine in facing relation to another relatively rotatable component thereof with a small gap therebetween. The magnets are secured by embedding them in a bonding material surrounding the peripheral edges of the magnets and at least a portion of the sides thereof facing the gap and leaving an area of said sides directly exposed to the gap to maintain good electrical properties and machine performance without necessitating an increase in the gap.

### BACKGROUND OF INVENTION

This invention relates to a rotary electric apparatus and more particularly to animproved construction for firmly securing the permanent magnets while maintaining good electrical performance.

Normally these rotary electric apparatus, which may comprise either motors or generators are comprised of cooperating relatively rotatable components comprised of a plurality of circumferentially spaced permanent magnets that cooperate with the tips of a plurality of pole teeth around which electrical coils are wound. If the apparatus is a motor, the coils are sequentially energized to effect rotation. If it is a generator it is driven and a voltage is generated in the coil windings. These type of apparatus may assume many forms.

There conventional magnetic field type rotary electric devices adopt either an inner permanent magnet (IPM) structure in which permanent magnets for forming a magnetic field are buried in a stator yoke (core) or rotor yoke made from magnetic materials or the surface permanent magnet (SPM) structure in which the permanent magnets are disposed on the surface of the core at desired intervals.

Japanese Published Application 2002-27690 shows a type of IPM structure. In this construction, to facilitate flux distribution, a semi cylindrical bulge section is disposed on the outer edge of the core on the diameter line connecting the center line of the permanent magnet and the center of the rotor core.

These IPM constructions have disadvantages because a part of the flux emitted from the permanent magnets to form the magnetic fields is shunted and flows through the inside of the core through the resulting gap between the core outer edge and the permanent magnet. It also causes flux leakage because it does not reach the rotor core or stator core, and therefore results in efficiency reduction that produces a drop in torque output if the machine is motor or a reduction of electromotive force if the machine is generator.

With the SPM structures, the permanent magnets for forming a magnetic field are implanted on the surface of the rotor core and directly face the wound poles of the stator. Thus the permanent magnets can be positioned as close as possible to the magnetic pole of the coil. The flux flow of the permanent magnets acts on the windings through the very small gap. This permits the waveform of the electromotive force to approaches an approximately sinusoidal waveform. In this way that torque pulsation can be reduced. Therefore, there is a trend toward a greater use of the SPM type of structures.

Japanese Published Application 2000-166141A shows a SPM type of structure. In this arrangement, the permanent magnets are carried by the rotor and are bonded in grooves formed on the outer peripheral surface of the cylindrical rotor at predetermined intervals. The permanent magnets have a semi cylindrical shape with a curved surface that faces the wound pole teeth of the stator. The gap length between the permanent magnet surfaces and the stator is different on opposite sides of the recess so as to reduce torque ripple by producing induction voltage including high harmonic content.

There are, however problems dealing with the attachment of the magnets in connection with the SPM type of structure. These may be best understood by reference to the examples of prior art structures commonly employed as shown in FIGS. 1 and 2, 3 and 4.

Referring first to the prior art example of FIGS. 1 and 2, these figures show a rotor construction of a permanent magnet motor of the SPM type of constructionin which the rotor which carries the magnets is located inside the stator. As seen in these figures, a rotor indicated generally ask comprises a plural number of permanent magnet pieces 12 glued with adhesive in respective slots 13 formed in the cylindrical outer surface 14 of a rotor core 15. The outside magnetic pole surface 12a of each permanent magnet piece 12 is rounded in a cylindrical shape to face a stator (not shown) that encircles the rotor 11.

The rotor 11 is journalled for rotation about an axis by two bearings 16 and 17 at two axially spaced positions along a rotor shaft 18. This rotor 11 represents a typical conventional magnet holding construction in which the adhesively secured permanent magnet pieces 12 are retained from coming off the rotor core 15 under the influence of centrifugal force by encasing the entire outside cylindrical surface of the rotor 11 including the permanent magnet pieces 12 with molding resin 19.

The disadvantage of the construction in which the rotor 11 is entirely wrapped around with the molding resin 19 the gap between the rotor and specifically the magnet surfaces 12a and the stator is reduced by the thickness of the molding resin layer 19. Thus to avoid mechanical interference, the gap must be increased by at least the thickness of the resin 19. As a result, the magnetic interaction between the rotor and stator is weakened, which leads to a decreased output torque in the case of a motor or decreased electrical output in the case of a generator.

Referring now to the prior art construction shown in FIG. 3, this shows another conventional DC motor of an inner rotor construction. In this example, a rotor indicated generally at 21 is comprised of a laminated rotor core having a plurality of magnetic pole portions 22 around which coil windings(not shown) are place. These windings extend into slots 23 formed between the pole teeth 22. The pole teeth have outermost surfaces of an arcuate shape 24. The rotor 21 is journalled on a motor shaft (not shown) that passes through a shaft hole 25 bored in the center of the core of the rotor 21.

A stator indicated generally at 26 is placed outside the rotor 21 with an annular gap 27formed therebetween. A plurality of permanent magnets 28 are placed at equal circumferential intervals in the annular gap 27 on a cylindrical inner surface 29 of the stator 26. These magnets 28 are of a curved shape to conform to the inside cylindrical surface 29 of the stator 26 and oppose the arcuate outermost surfaces 24 of the respective magnetic pole portions 22 of the rotor 21. Small gaps are formed therebetween for clearance reasons.

The curved magnets 28 are secured to the stator 26 only by means of an adhesive to adhesively bond the inside surface 28a of the magnets 28 and to the inside cylindrical surface 29 of the stator 26. Therefore, the DC motor of the conventional inner motor constitution does not employ the technique of securing the magnets 28 encasing it with a molding resin agent and reliance is placed solely on the adhesive to prevent separation.

FIG. 4 shows another prior art construction, similar to that of FIG. 3, and in this case comprises, for example, a generator of a conventional outer rotor constitution commonly used in motorcycles. This conventional generator comprises a stator indicated generally at 31 located radially inside a rotor, indicated generally at 32. AS with the construction of FIG. 3, coils (not shown) are wound around poles of the stator 31. When driven these coils generate the electricity output.

The rotor 32 is provided with four permanent magnets 33 of a arcuate shape that are secured to an inside cylindrical surface 34 of the rotor 32 at equal circumferential intervals.

Each of the four, arcuate shaped permanent magnets 33 is magnetized with three poles of alternation polarity to act as if three permanent magnets were placed in tight contact with each other.

This generator of the outer rotor constitution is to produces an alternate current output from the coils of the stator 31 as the rotor 32 is rotated by external power and is used as a power for motorcycles to light up lamps and the like. However, this generator of the conventional outer rotor constitution only employs the method of adhesive securing the arcuate shaped permanent magnets 33 to the inside cylindrical surface 34 of the rotor 32 and involves no technical concept of cast-wrapping and mold-securing the permanent magnets 33 using the molding resin agent. Thus these prior art constructions raise the risk of the permanent magnets becoming detached in operation.

It is therefore a principal object of the invention to provide a rotating electrical machine that is extremely efficient, but also has a very secure arrangement for affixing the permanent magnet so that the risk of detachment is substantially eliminated.

### SUMMARY OF INVENTION

This invention is adapted to be embodied in a rotating electrical machine having a component having a cylindrical surface adapted to face a gap defined by a cooperating cylindrical surface of formed by poles wound with electrical coils. A plurality of plate type permanent magnets are spaced around the cylindrical surface. A bonding agent surrounds the peripheral edges of the magnets and at least a portion of the sides thereof facing the gap and leaving an area of said sides directly exposed to the gap. The bonding agent is affixed to the cylindrical surface.

### BRIEF DESCRIPTION OF DRAWINGS

FIG. 1 is a side elevational view, with a portion broken away, of rotor of a rotating electrical machine of a first prior art type.

FIG. 2 is a cross sectional view taken along the line 2-2 of FIG. 1.

FIG. 3 is a cross sectional view taken perpendicular to the rotational axis of a rotating electrical machine of a second prior art type.

FIG. 4 is a cross sectional view taken perpendicular to the rotational axis of a rotating electrical machine of a third prior art type.

FIG. 5 is a side elevational view, with a portion broken away, in part similar to FIG. 1 but showing the rotor of a rotating electrical machine of a first embodiment of the invention.

FIG. 6 is a cross sectional view taken along the line 6-6 of FIG. 5.

FIG. 7 is a graphical view showing the electromotive force of the machine of FIGS. 5 and 6 in relation to the electrical angle.

FIG. 8 is an enlarged, partial cross sectional taken along an axial plane of a rotating electrical machine of a second embodiment of the invention.

FIG. 9 is an cross sectional taken along an axial plane of a rotating electrical machine of a third embodiment of the invention.

FIG. 10 is an cross sectional taken along an axial plane, in part similar to FIG. 9, of a rotating electrical machine of a third embodiment of the invention.

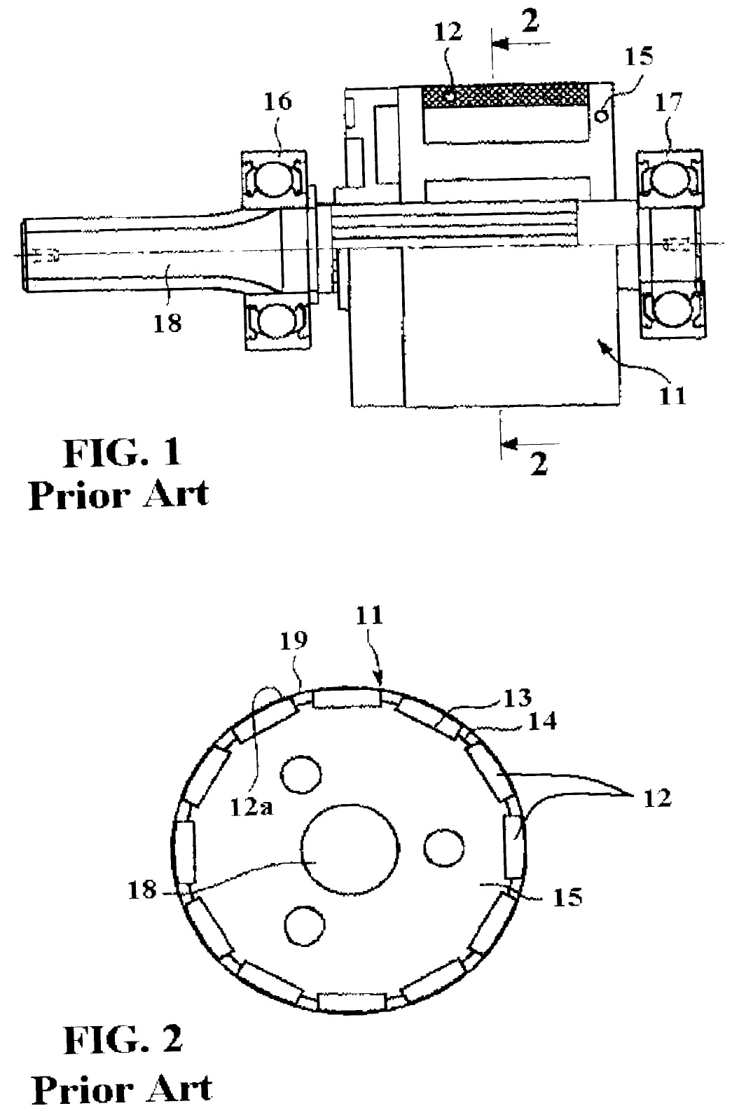

### DETAILED DESCRIPTION

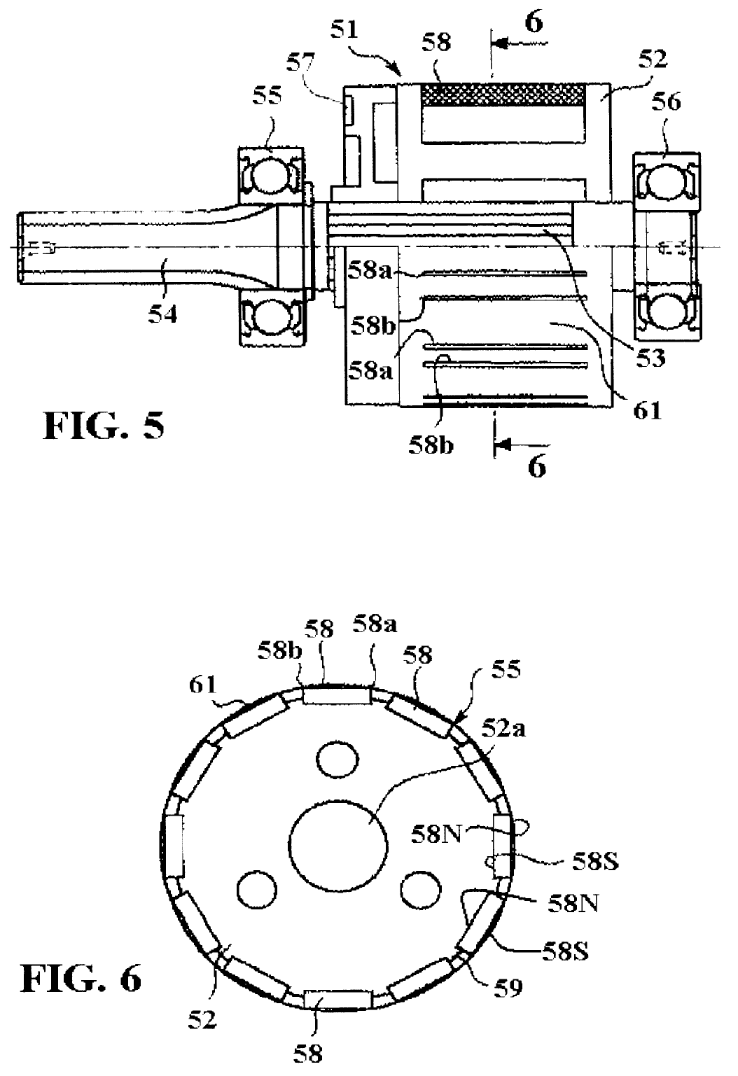

Referring now in detail to the drawings and initially to the embodiment of FIGS. 5 and 6, a portion of a rotating electrical machine of the inner rotor type, with the rotor placed inside the stator is shown although from the following description it will be apparent to those skilled in the art that the invention is not so limited.

The rotary electric apparatus of this embodiment is comprised of a rotor, indicated generally by the reference numeral 51. The rotor 51 includes a rotor core 52 made of a magnetic material. The rotor core 52 has a splined opening 52a for non-rotatably coupling it to the splines 53 of a rotor shaft 54.

The rotor 51 is journalled relative to a stator (not shown) by means of antifriction bearings 55 and 56 provided on both ends of the rotor shaft 54.

An annular sensor magnet 57 having circumferentially spaced magnetic poles of alternate polarity is attached to the side face of rotor core 52 facing the front bearing 55. The sensor magnet 57 makes it possible to measure the rotational angle of the rotor 51through cooperation with a magnetic sensor element such as a Hall effect element (not shown) carried by the associated stator (not shown).

A plurality of plate type permanent magnets 58 are secured by adhesion of an adhesive or the like at even or uneven intervals into slots formed in an outside cylindrical surface 59 of the rotor core 52 of the rotor 51. These permanent magnets 58 are securely held in place by molding preferably by a thermosetting molding resin 61 in a manner to be described shortly.

The permanent magnets 58 are made by cutting a magnetic material into pieces having a flat rectangular shape of the desired dimension. The radially inner and outer rectangular flat surfaces of the cut pieces are suitably magnetized to be N pole and S pole surfaces 58N and 58S. According to the magnetizing method generally practiced, one of the rectangular surfaces of the rectangular metallic material for each magnet is secured into a shallow groove 59 formed in the outside cylindrical surface of the rotor core 52 with an adhesive, and magnetized to be a permanent magnet by subjecting to a strong magnetic field. The polarity of the poles is alternated circumferentially around the core 52.

After gluing and positioning the permanent magnets 58 to the rotor core 52 as described above, they are placed into a molding die (not shown). The inside surface of the molding die has the shape of a cylinder that is tangent to the circumferential ends 58a and 58b of the magnets 58 as positioned on the rotor core 52. Then, the molding resin 61 for partially covering and securely holding the permanent magnets 58 is poured into the molding die and permitted to set.

With the above arrangement, a gap is formed between the central part of the flat magnetic pole surface 58N or 58S of the respective permanent magnets 58 and the inside surface of the molding die. Therefore, the molding resin 61 fills the gap and also surrounds the outside cylindrical surface 59 between the magnets 58 and both end areas of the rotor core 52 where the permanent magnets 58 are not glued so as to finish molding the permanent magnets 58 into a unit with the core 52.

Referring now to FIG. 6, it will be seen that the both circumferential width ends 58a and 58b of each magnetic piece 58 are not covered with the molding resin 61 but exposed. Only the central area of each flat magnetic pole surface 58N or 58S is covered with the molding resin 61.

As a result, the rotor 51 can rotatably supported without any mechanical interference with the stator even if no measure is taken to increase the amount of gap for magnetic interaction between the rotor 51 and the inside cylindrical surface of the stator in consideration of the covering layer of the molding resin 61. Equally as important, since the magnets 58 are only partially covered with the molding resin 61, the electrical efficiency is only slightly reduced. This is advantageous in terms of the performance of the rotary electric apparatus used as a motor or generator because there is no significant reduction in output torque in the case of a motor or generated output in the case of a generator while increasing the strength of holding the permanent magnets 58.

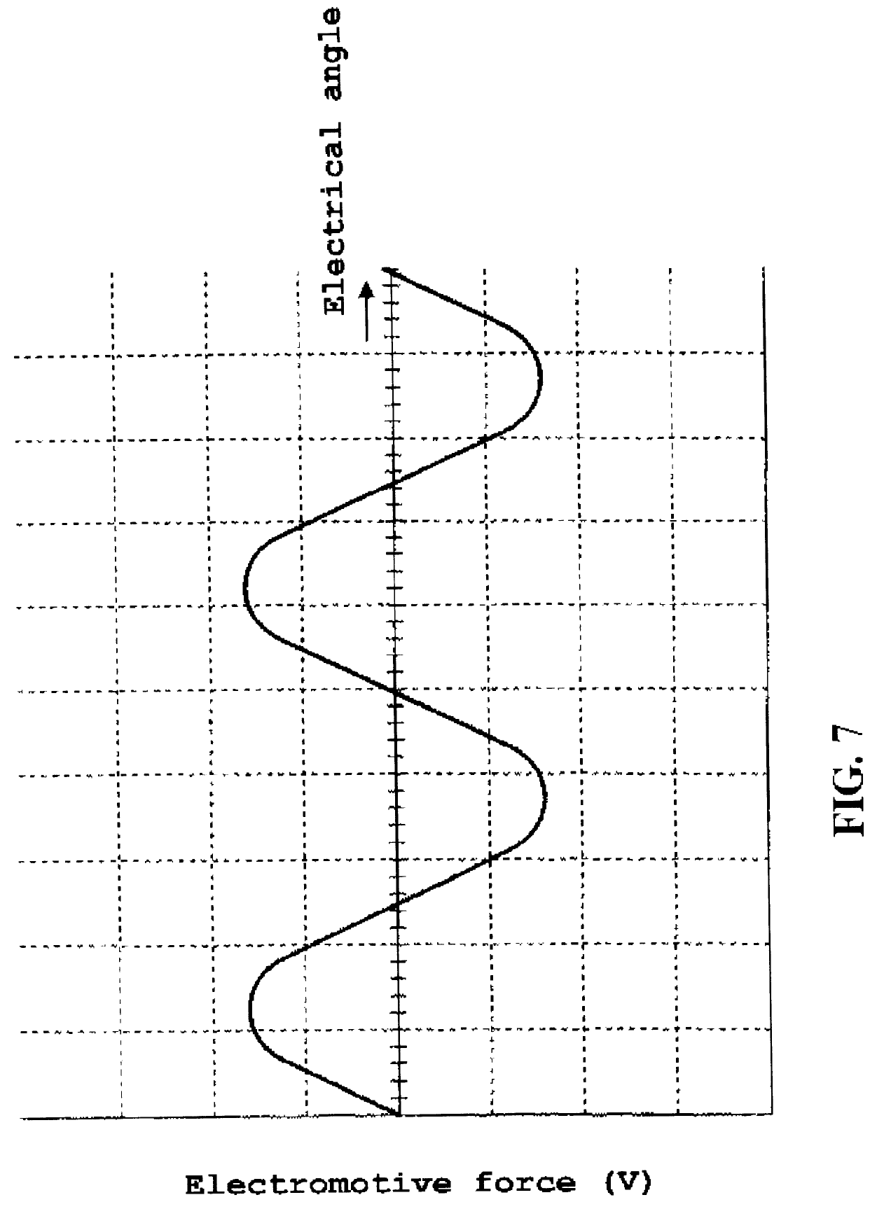

FIG. 7 is a graphical view showing the back electromotive force measured by rotating the rotor 51 of a motor constructed in accordance with the embodiment of FIGS. 5 and 6. The back electromotive force shows a very smooth sine curve. This confirms that the output torque characteristic will be smooth with cogging or torque pulsation sufficiently reduced.

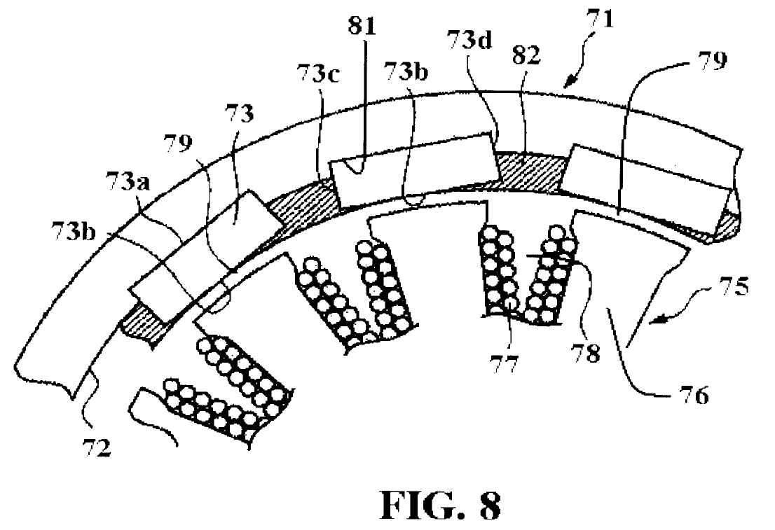

While the above embodiment is described about a rotary electric apparatus of the SPM type of the inner rotor constitution as an example in which the rotor 51 is placed inside the stator, the technical concept of this invention can also be applied to the SPM type of the outer rotor constitution in which the rotor is placed outside of the stator. Such an embodiment is shown in FIG. 8 and will now be described in detail by reference to that figure.

FIG. 8 is a partial sectional view of the constitution of an embodiment of an outer rotor, SPM type of rotary electric apparatus. A rotor, indicated generally at 71 is formed to as an annular member. Flat plate-like permanent magnets 73 that are substantially the same as the permanent magnets 12 of the previous embodiment are placed in circumferential positions at equal intervals on a cylindrical inside surface 72 of the annular flywheel member 71.

The magnets 73 have their radially inner faces 74 facing a stator, indicated generally at 75. The stator 75 is made by laminating a large number of stator cores of a magnetic material to form equally spaced, radially extending pole teeth 76 each of the pole teeth 76 is wound with a respective coil 77. The wound coils 77 extend through slots 78 formed between the pole teeth 76. The rotor 71 and specifically faces 73b of the permanent magnets 73 are spaced from the tips of the pole teeth 76 of the stator 75 by a gap 79.

Each of the permanent magnets 73 has radially spaced outer and inner flat magnetic pole surfaces 73a and 73b, respectively. Each outer magnetic pole surface 73a is secured in a respective shallow slot 81 formed in the inner cylindrical surface 72 of the flywheel member 71 by suitable means such as by an adhesive.

The radially inner magnetic pole surface 73b of each permanent magnet 73 is covered with a molding resin 82. The resin 82 is cylindrical in shape with its inner circumferential area tangent to the faces 73b. Thus unlike the previous embodiment, a central area between the circumferential end portions 81c and 81d is exposed while these end portions 81c and 81d are covered.

The covering layer of the molding resin 82 is formed by pouring and solidifying the molding resin 82 into a molding die formed along an envelope cylinder centered on the center of the stator 75 extending to cover the both width end portions 81a and 81b of each of the permanent magnets 73. The envelope cylinder is defined to be a cylinder tangent to the inside central area of each permanent magnet 73. Therefore, when the magnetic pieces 73 are covered with the molding resin 82, the central area is exposed out of the molding resin layer to face directly the stator 75.

Since the resin covering layer 82, like the previous embodiment, covers only a portion of the face 73b of each permanent magnet 73, (the end portions in this embodiment as opposed to the central portion as in the embodiment of FIGS. 5 and 6) mechanical interference of the rotor 71 with the stator 75 as the rotor 71 rotates can be avoided without increasing the gap relative to the stator 75. As a result, it is possible to firmly secure each permanent magnet 73 for producing a magnetic field for the rotor 71 without impairing the magnetic performance of the associated rotary electric apparatus be it either a motor or a generator.

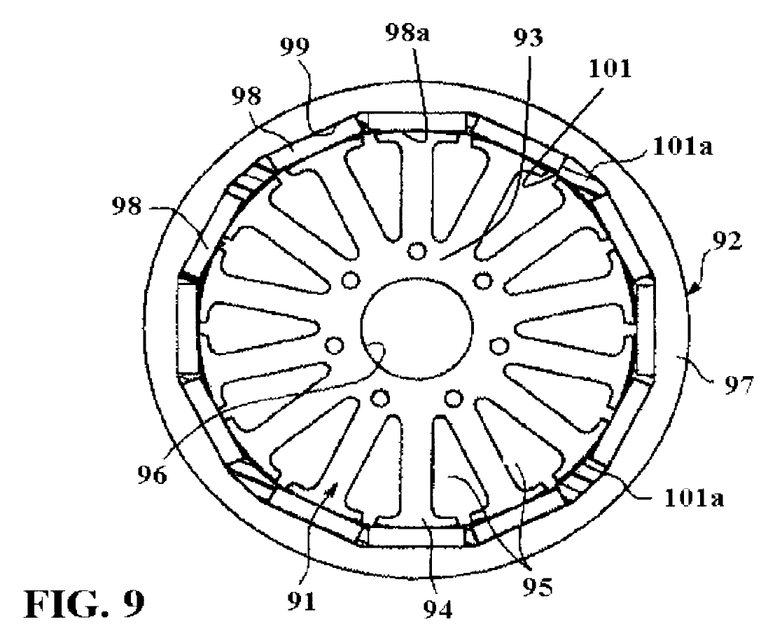

In each embodiment already described, the permanent magnets have all been of the same circumferential width and spacing. The invention, however, is not so limited, as will be apparent from the following description of the embodiment of FIG. 9.

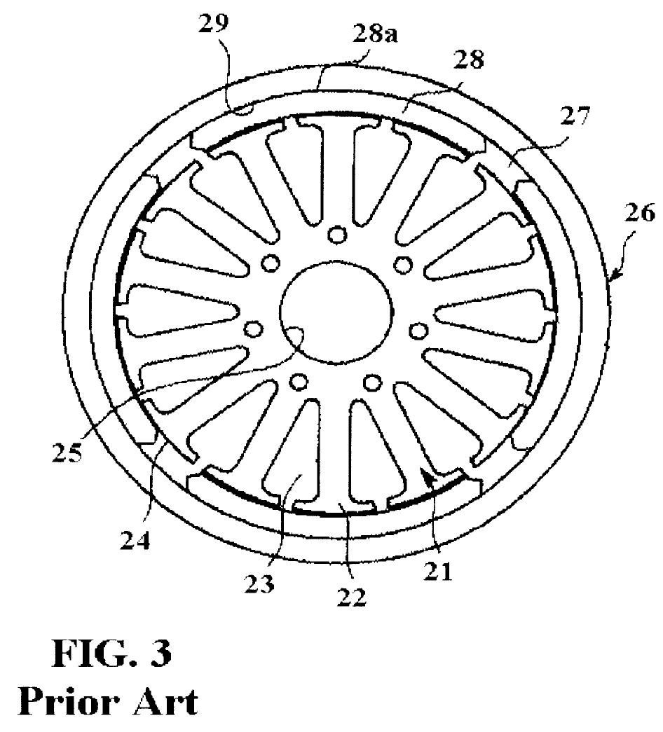

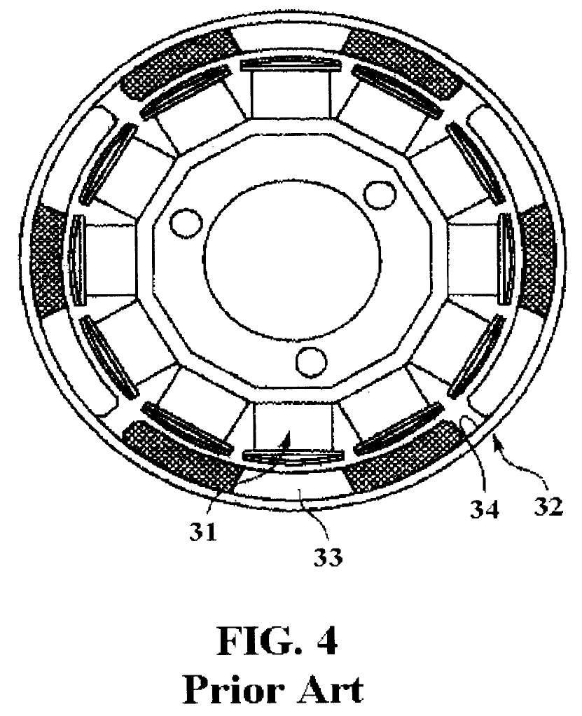

FIG. 9 shows a rotary electric apparatus as still another embodiment of the invention, constituted as an inner rotor type of DC motor like the DC motor of the conventional inner rotor constitution shown in FIG. 3. The DC motor of this embodiment comprises a rotor, indicated generally at 91 and a stator indicated generally at 92.

The rotor 91 is made up of laminated magnetic steel plates having a core portion 93 from which pole teeth 94 radially extend. Coil windings (not shown) encircle the pole teeth 94 and extend into slots 95 formed between the magnetic pole teeth 94. The rotor 91 is supported for rotation by a rotor shaft (not shown) that is nonrotatably fixed in a center hole 96 of the core portion 93.

The stator 92 comprises an annular housing 97. A plural number of flat plate-like permanent magnets 98 are placed and secured in groups of three, in this embodiment, to an inside cylindrical surface 99 of the annular housing 97. These groups of magnets 98 are positioned in specified plural (four in the drawing) circumferentially spaced positions.

The permanent magnets 98 are each magnetized to have radially spaced poles of opposite circumferentially spaced polarity. Preferably each of the groups of three magnets 98 are arranged to be of the same magnetic pole sequence. Of the flat plate-like permanent magnets 98, as shown, the two that are diametrically opposite each other are positioned to be in the same phase in the circumferential direction with the magnetic pole teeth 94 of the rotor 91. Other permanent magnets 98 in two adjacent places are displaced in the circumferential direction with the magnetic pole teeth 94 of the rotor 91, so that attracting and repelling forces are produced between the permanent magnets 98 of the stator 92 and the magnetic pole teeth 94 of the rotor 91 as the coils (not shown) are energized, to cause rotation of the rotor 91.

As with the preceding embodiments, the permanent magnets 98 are first affixed to the stator surface 99 by adhesive bonding, as previously described. Here, the flat plate-like permanent magnets 98, three for each of the four positions, have their radially outer flat faces firmly fixed to the inside cylindrical surface 99 of the housing 97 of the stator 92. Then a molding resin 101 of thermosetting property such as unsaturated polyesters deposited in the manner previously described in a cylindrical pattern tangent to the magnetic pole face 98a that faces the magnetic pole teeth 94 of the rotor 91. This results, as with the embodiment of FIG. 8 only the width central area of the flat magnetic pole surface 98a being exposed. However the circumferential end areas on both sides of the central area are covered as the molding resin 101 solidifies.

The above construction in which the central area of the magnetic pole surfaces 98a is left uncovered with the molding resin 101 makes it possible to eliminate the presence of molding resin layer in the gap through which the flat plate-like permanent magnets 98 face the magnetic pole teeth 94 of the rotor 91. Therefore, the amount of gap between the rotor 91 and the stator 92 can be maintained as small as possible and the motor output can be prevented from lowering due to the amount of the gap.

The molding resin 101 also fills spaces, four are shown as present in the circumferential direction, between two adjacent groups of the flat plate-like permanent magnets 98, with each group made up of three permanent magnets 98. Therefore, the molding resin portion 101a shown with hatching extends in the circumferential direction and solidifies. The molding resin 101 also fills the tiny space present in the circumferential direction between adjacent flat plate-like permanent magnets 98 of each group and solidifies. This contributes together with the molding resin portion 101a to firmly securing the permanent magnets 98 and reliably prevents the flat plate-like permanent magnets 98 from separating and coming off while the motor is in operation.

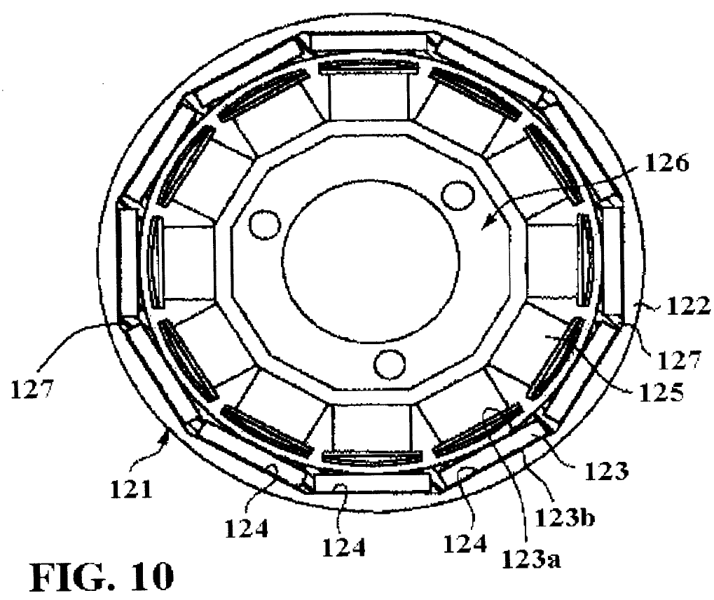

FIG. 10 is a sectional view of still another embodiment of the invention, an example of a construction similar to the generator of the outer rotor type described before in reference to FIG. 8, arranged to prevent generated output from decreasing due to increase in the amount of gap between the rotor and stator while fixing the flat plate-like permanent magnets of the invention by means of molding resin.

As seen in FIG. 10, a rotor, indicated generally at 121, is comprised of an annular flywheel 122. A plurality of flat plate-like permanent magnets 123, made as previously described, are placed in a plurality of positions in slots 124 formed on the inside cylindrical surface of the flywheel 122, with the flat plate surfaces 123a forming poles on one radial side of the permanent magnets 123 facing a like number of magnetic pole teeth 125 of an inner stator, indicated generally at 126. The opposite poles 123b of the magnets 123 are adhesively fixed in the slots 124, as previously described.

As with the previous embodiments, the pole teeth 125 are wound with electric coils. In this case, since the number of the flat plate-like permanent magnets 123 is the same as the number of the magnetic pole teeth 125 provided on the stator 126, as the flat plate-like permanent magnets 123 rotate they will face the next magnetic pole tooth 125 of the stator 126 every time the rotor 121 rotates by an angle of 360 degrees divided by the number of pole teeth 125 and magnets 123.

As with the previously described embodiments, the flat plate-like permanent magnets 123 in are magnetized so that polarities of N and S change alternately for one magnet to another in the circumferential direction. In other words, if the surface of one permanent magnet 123 facing the magnetic pole portion 125 of the stator is magnetized to be an N pole radially with respect to the center of the generator and the opposite surface is magnetized to be an S pole, the permanent magnet 123 next in the circumferential direction is magnetized so that the surface facing the magnetic pole portion 125 of the stator is radially an S pole while the opposite surface is an N pole. This arrangement makes it possible to generate electricity from the coils wound around the magnetic pole teeth 125 of the stator as the rotor 121 rotates outside the stator 126.

The flat plate-like permanent magnets 123 are firmly fixed to the inside cylindrical surface 52 of the flywheel 122 of the rotor 121 as a thermosetting molding resin 127 such as unsaturated polyester solidifies. The resin 127 covers the both width end areas of the flat plate surface 123a and also the gap between adjacent permanent magnets 123, while leaving the central area of the flat plate surface 123 uncovered In the above arrangement, like the embodiment described before in reference to FIG. 9, the central area of the flat plate surfaces 123 of the permanent magnets 123 facing the magnetic pole portion 125 of the stator 126 are not covered with the molding resin 127 while only the both side areas are covered with the molding resin 127. Therefore, it is not necessary to increase the amount of gap between the rotor 121 and the stator 126 according to forming the layer of the molding resin 127. As a result, the permanent magnets 123 are firmly fixed without decrease in the generator output, and the risk of the flat plate-like permanent magnets 123 separating and coming off due to rotating operation of the rotor 121 can be reliably avoided.

Thus from the foregoing description it should be readily apparent that the described embodiments make it possible to firmly fix the permanent magnets to either the rotor or stator by covering the permanent magnets with the molding resin while leaving a substantial part of the flat magnetic pole surfaces uncovered. This also makes it possible to maintain a small gap between the rotor and stator without increasing the gap by the thickness of a covering layer of the molding resin. As a result, permanent magnet pieces for producing magnetic field can be firmly fixed without sacrificing output torque or generated electromotive force when the invention is applied to the rotary electric apparatus, whether the motor or generator. This leads to the effects of improving the functional reliability and extending the service life of the rotary electric apparatus, and further makes it possible to arrange that the rotor and stator face each other through a small gap while sufficiently preventing the permanent magnet pieces for separating. Of course those skilled in the art will readily understand that the foregoing description is of preferred embodiments and various changes and modifications may be made without deviating from the spirit and scope of the invention, as defined by the appended claims.

1. A rotating electrical machine having a component having a cylindrical surface adapted to face a gap defined by a cooperating cylindrical surface of formed by poles wound with electrical coils, a plurality of plate type, planar permanent magnets spaced around said cylindrical surface, and a bonding agent adhered to said cylindrical surface and surrounding the peripheral edges of said magnets and at least a portion of the sides thereof facing the gap and leaving an area of said sides directly exposed to the gap.

2. A rotating electrical machine as set forth in claim 1 wherein the bonding agent covers only the circumferential ends of the magnet sides facing the gap leaving the circumferential center portion thereof exposed.

3. A rotating electrical machine as set forth in claim 1 wherein the bonding agent covers only the circumferential center portion of the magnet sides facing the gap leaving the circumferential ends thereof exposed.

4. A rotating electrical machine as set forth in claim 1 wherein the sides of the permanent magnets facing the cylindrical surface are adhesively secured thereto.

5. A rotating electrical machine as set forth in claim 4 wherein the sides of the permanent magnets facing the cylindrical surface are positioned in slots formed therein.

6. A rotating electrical machine as set forth in claim 4 wherein the bonding agent is formed in a shape having a cylindrical surface facing the gap which cylindrical surface is tangential to the magnet sides facing the gap.

7. A rotating electrical machine as set forth in claim 6 wherein the bonding agent covers only the circumferential ends of the magnet sides facing the gap leaving the circumferential center portion thereof exposed.

8. A rotating electrical machine as set forth in claim 6 wherein the bonding agent covers only the circumferential center portion of the magnet sides facing the gap leaving the circumferential ends thereof exposed.
